(19) United States
(12) Patent Application Publication
(10) Pub. No.: US 2010/0322504 A1
(43) Pub. Date: Dec. 23, 2010

(54) IMPURITY DETECTION DEVICE

(75) Inventor: Sheng-Hui YANG, Taichung City (TW)

Correspondence Address: MCNEES WALLACE & NURICK LLC, 100 PINE STREET, P.O. BOX 1166, HARRISBURG, PA, 17108-1166, US

(73) Assignee: CVC TECHNOLOGIES INC., Taichung County (TW)

(21) Appl. No.: 12/684,223

(22) Filed: Jan. 8, 2010

(30) Foreign Application Priority Data
Jun. 22, 2009 (CN) 200920159402.0

(51) Int. Cl. G06K 9/00

(52) U.S. Cl. 382/142

(57) ABSTRACT

An impurity detection device includes a rotation unit, a light emitting unit, a light sensor unit, and an analysis unit. The rotation unit on which the bottle is loaded spins the bottle at a high speed and subsequently and instantaneously terminates spinning of the bottle. The light emitting unit generates light to pass through the bottle. The light sensor unit detects the light passing through the bottle, and captures a plurality of images of the light passed through the bottle after spinning of the bottle has been terminated and at different time intervals. The analysis unit receives the captured images from the light sensor unit, and compares the captured images to determine whether an impurity is present in the bottle.

### CROSS-REFERENCE TO RELATED APPLICATION

This application claims priority of Chinese Application No. 200920159402.0, filed on Jun. 22, 2009.

### BACKGROUND OF THE INVENTION

1. Field of the Invention

The present invention relates to a detection device, more particularly to an impurity detection device adapted for detecting impurities in liquid filled in a transparent bottle.

2. Description of the Related Art

Pharmaceutical products, vaccines, etc. (hereinafter referred to as medicinal agents) are special in that any flaws in medicinal agents have a direct bearing on human safety. Thus, the control of the quality of medicinal agents is oftentimes much stricter than it is with other products. During the processes of material selection, shipment, detection, etc., the quality of medicinal agents may be affected if there is carelessness in any of these processes.

Referring to FIG. 1, a medicinal agent in liquid form is sealed and filled in a transparent bottle 1. The transparent bottle 1 has a bottom wall 11 and a surrounding wall 12 defining a sealed space 10. Alight emitting device 21 of a conventional impurity detection device generates light to pass through the bottle 1, and a light receiver device 22 of the conventional impurity detection device receives the light passing through the bottle 1. Since the property of light transmittance may be affected when an impurity (A) is present in the liquid, by using the conventional impurity detection device, the impurity (A) can be detected in the bottle 1.

However, many impurities, such as glass, metal, fiber, hair, and so on, may deposit on the bottom wall 11 of the bottle 1 and remain thereat in a motionless state. Therefore, when the light passes through the bottle 1, such impurities may go undetected, causing detection errors. Moreover, the light generated from the light emitting device 21 scatters so all of the light passing through the bottle 1 can not be utilized effectively, causing the contrast between light and dark to be unclear. This leads to further inaccuracies in detection.

### SUMMARY OF THE INVENTION

Therefore, the object of the present invention is to provide an impurity detection device for accurately detecting impurities in liquid filled in a transparent bottle.

Accordingly, an impurity detection device of the present invention comprises a rotation unit, a light emitting unit, a light sensor unit, and an analysis unit. The rotation unit on which the bottle is loaded spins the bottle at a high speed and subsequently and instantaneously terminates spinning of the bottle. The light emitting unit generates light to pass through the bottle. The light sensor unit detects the light passing through the bottle, and captures a plurality of images of the light passed through the bottle after spinning of the bottle has been terminated and at different time intervals. The analysis unit receives the captured images from the light sensor unit, and compares the captured images to determine whether an impurity is present in the bottle.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic view of a conventional impurity detection device;

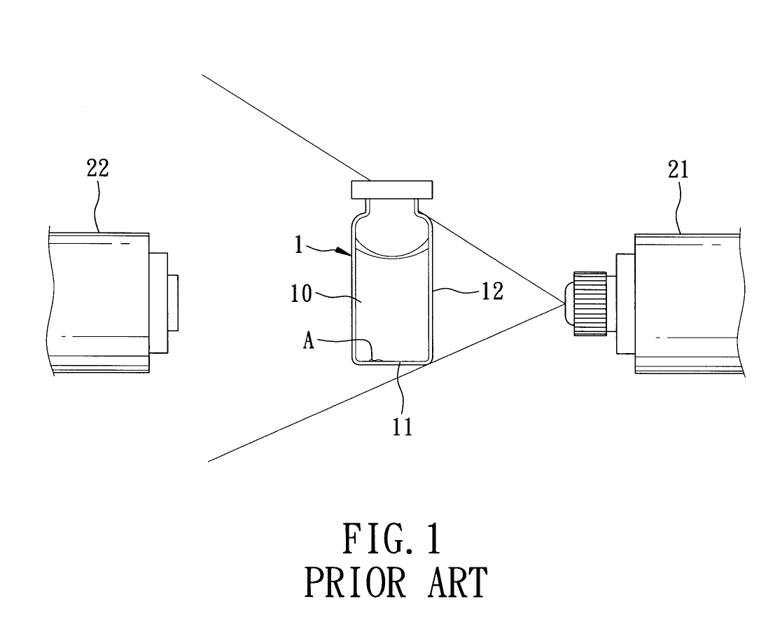

FIG. 2 is a block diagram of a preferred embodiment of an impurity detection device according to the present invention;

FIG. 3 is a top view of the impurity detection device of the preferred embodiment;

FIG. 4 is an exploded perspective view of a rotation unit of the preferred embodiment;

FIG. 5 is a sectional view of the rotation unit of the preferred embodiment;

FIG. 6 is a perspective view of a light emitting unit and a light sensor unit of the preferred embodiment;

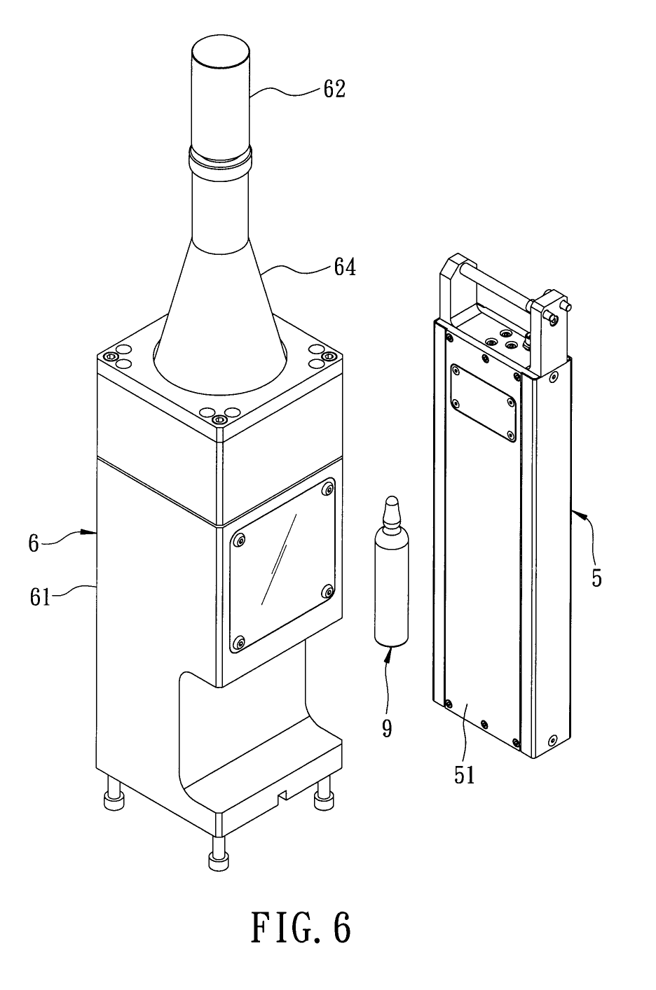

FIG. 7 is a sectional view of the light emitting unit and the light sensor unit of the preferred embodiment to illustrate light transmission therebetween;

FIG. 8 a side view of a bottle to illustrate an impurity floating in a whirlpool created in the bottle by the preferred embodiment; and

FIG. 9 is a schematic view which is used to describe how images are captured by an image capturing device of the preferred embodiment at different time intervals so as to generate a Z diagram of the impurity in the bottle.

### DETAILED DESCRIPTION OF THE PREFERRED EMBODIMENT

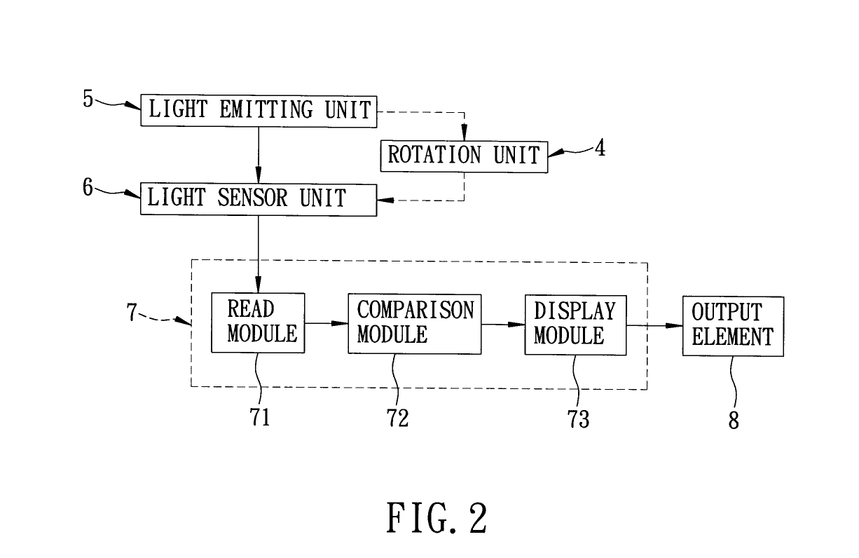

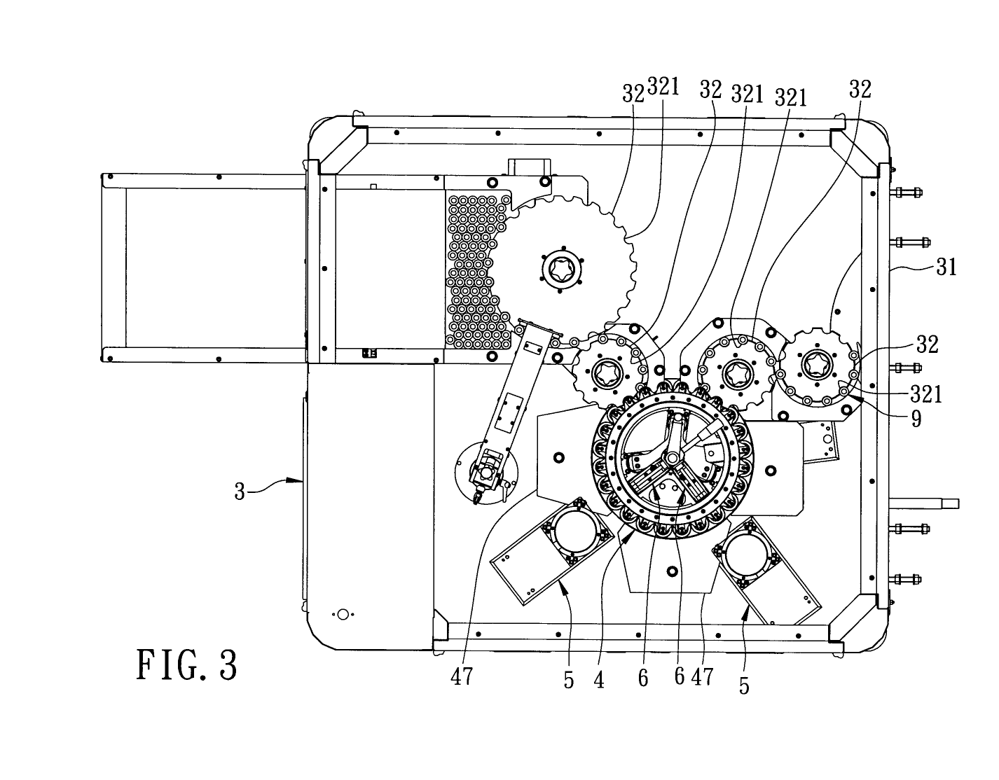

Referring to FIGS. 2 and 3, a preferred embodiment of an impurity detection device according to the present invention is mounted on an impurity detection platform 3. The impurity detection platform 3 has a machine platform 31, and a plurality of gearwheels 32 arranged along a guided direction. Each of the gear wheels 32 has a plurality of grooves 321 formed along an outer periphery thereof. The impurity detection device comprises a rotation unit 4, a light emitting unit 5, a light sensor unit 6, and an analysis unit 7. In some embodiments, the impurity detection unit comprises a second light emitting unit 5 and a corresponding second light sensor unit 6.

The rotation unit 4 on which the bottle 9 is loaded spins the bottle 9 at a high speed and subsequently and instantaneously terminates spinning of the bottle 9. The light emitting unit 5 generates light to pass through the bottle 9. The light sensor unit 6 detects the light passing through the bottle 9, and captures a plurality of images of the light passed through the bottle 9 after spinning of the bottle 9 has been terminated and at different time intervals. The analysis unit 7 receives the captured images from the light sensor unit 6, and compares the captured images to determine whether an impurity is present in the bottle 9.

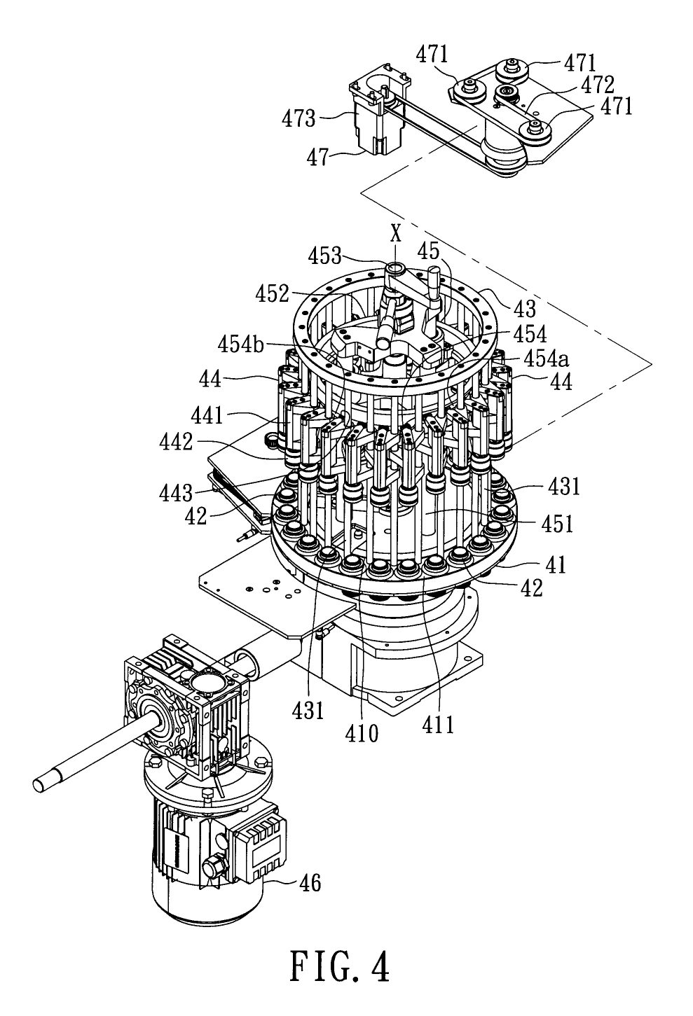

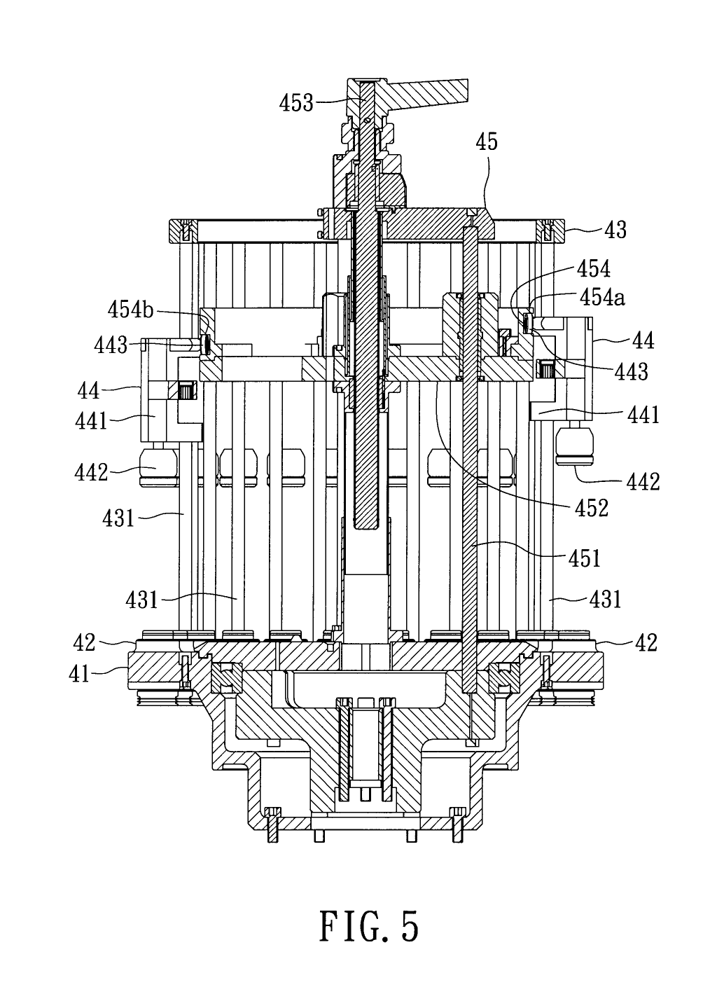

Referring additionally to FIGS. 4 and 5, the rotation unit 4 is disposed on the machine platform 31, and includes a rotation platform 41 rotating about a main axis (X) thereof, a spin element 42, a framework 43, a limiting component 44, a linking assembly 45, a rotation motor assembly 46, and a spin motor assembly 47. In some embodiments, the rotation unit 4 includes a plurality of spin elements 42 and a plurality of limiting components 44 corresponding respectively to the spin elements 42.

The rotation platform 41 has a body portion 411 that surrounds the main axis (X) of the rotation platform 41 and defines a hollow portion 410.

The spin element 42 is rotatably disposed on the rotation platform 41, and the bottle 9 is loaded on the spin element 42.

The framework 43 is disposed on the rotation platform 41, is located to one side of the spin element 42, and has a guide pillar 431. The guide pillar 431 is parallel to the main axis (X) of the rotation platform 41 and is disposed on the rotation platform 41. In some embodiments, the framework 43 has a plurality of guide pillars 431 that are disposed on the rotation platform 41, parallel to the main axis (X), and substantially equidistant from the main axis (X) and radially spaced apart from each other.

The limiting component 44 is slidably engaged with the framework 43, and has a holder 442, a first slide element 441, and a wheel 443. The holder 442 is rotatable freely about the main axis (X) of the rotation platform 41, and has a spacing relative to the spin element 42 so as to selectively secure and release the bottle 9 between the limiting component 44 and the spin element 42. The first slide element 441 is slidably engaged with the guide pillar 431. The holder 442 is mounted on the first slide element 441. The wheel 443 is rotatably disposed on the sliding framework 441 and faces the main axis (X) of the rotation platform 41.

The linking assembly 45 has a guiding component 452, a plurality of second slide elements 451, and a control assembly 453. The guiding component 452 is disposed to one side of the limiting component 44, and is formed with a guiding groove 454 on an outer peripheral surface of the guiding component 452 and that is slidably engaged with the wheel 443 of the limiting component 44. The guiding groove 454 has a raised segment 454a and a lowered segment 454b that are respectively raised and lowered in height along an axial direction of the main axis (X) of the rotation platform 41. The second slide elements 451 are parallel to the main axis (X) of the rotation platform 41, and extend through the hollow portion 410 and the guiding component 452. The control assembly 453 is disposed on the second slide elements 451, and extends through the guiding component 452 along the main axis (X) of the rotation platform 41. The control assembly 453 allows for manipulation so as to drive the guiding component 452 and the limiting component 44 to be displaced in the direction of the main axis (X) of the rotation platform 41 along the second slide elements 451 and the guide pillar 431.

The rotation motor assembly 46 is used for driving the rotation platform 41 to rotate about the main axis (X) thereof.

The spin motor assembly 47 is disposed on the machine platform 31. The spin motor assembly 47 drives the spin element 42 to rotate about its own axis and thereafter instantaneously terminate rotation. The spin motor assembly 47 includes a plurality of idle wheels 471, a band 472 mounted on the idle wheels 471, and a spin motor 473 for driving the band 472 so that the idle wheels 471 spin. The band 472 is in frictional contact with the spin element 42 to drive the spin element 42 to rotate about its own axis.

The light emitting unit 5 is disposed on one side of the body portion 411 outside the hollow portion 410, and includes a light transmission tube 51, a light emitting component 52 disposed in the light transmission tube 51 adjacent to an end thereof and which emits light, a first refractive lens 53 disposed in the light transmission tube 51 adjacent to the other end thereof, and a convex lens 54 disposed in the light transmission tube 51 between the light emitting component 52 and the first refractive lens 53. In this embodiment, the light emitting component 52 is a light emitting diode (LED).

The light sensor 6 is disposed on the other side of the body portion 411 inside the hollow portion 410 and opposes the light emitting unit 5. It is to be noted that in some embodiments, the locations of the light emitting unit 5 and the light sensor unit 6 may be exchanged. The light sensor unit 6 includes a reception light tube 61, an image capturing device 62 disposed on an end of the reception light tube 61, a second refractive lens 63 disposed in the reception light tube 61, and a telecentric lens 64 disposed between and interconnecting the image capturing device 62 and the reception light tube 61. The telecentric lens 64 allows parallel light to be focused onto the image capturing device 62, that is, reflective light or other directional light is not directed onto the image capturing device 62 due to the presence of the telecentric lens 64. In this embodiment, the image capturing device 62 includes a charge coupled device (CCD) image sensor. In other embodiments, the image capturing device 62 includes a complementary metal-oxide-semiconductor (CMOS) image sensor.

Referring to FIG. 2, the analysis unit 7 includes a read module 71 coupled to the light sensor unit 6, a comparison module 72 coupled to the read module 71, and a display module 73 coupled to the comparison module 72. The read module 71 reads the captured images captured by the light sensor unit 6. The comparison module 72 compares the captured images and generates a comparison result. The display module 73 is adapted to perform control to display the comparison result on an output element 8. In this embodiment, the output element 8 is a display screen.

Referring to FIG. 3, when the leftmost gear wheel 32 rotates, the grooves 321 receive the bottles 9, after which all the gear wheels 32 operate to move the bottles 9 along a path onto the rotation platform 41, then to remove the bottles 9 from the rotation platform 41. Hence, the bottles 9 are moved in and out of the impurity detection platform 3.

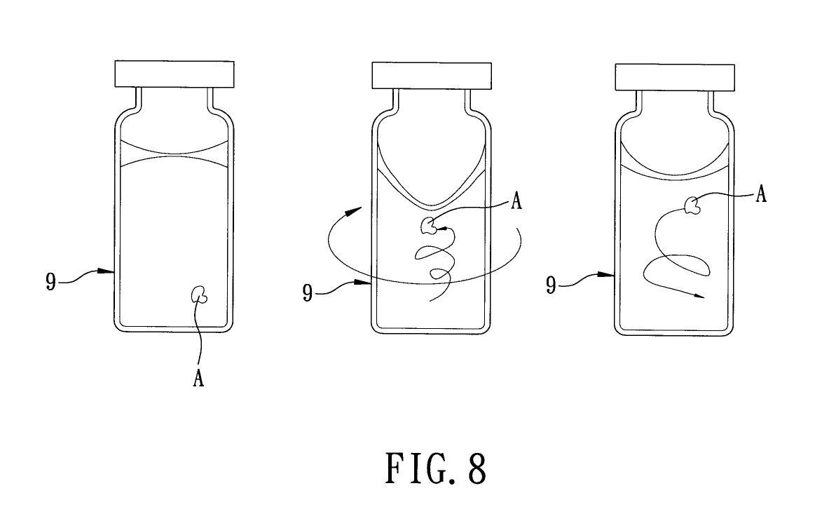

Referring to FIGS. 3, 4, and 5, and describing operation with respect to only one of the bottles 9, after the bottle 9 moves from one of the gear wheels 32 to the rotation platform 41 and is then disposed on the spin element 42, the limiting component 44 uses the first slide element 441 that is displaced downwardly when the wheel 443 is positioned at the lowered segment 454b of the guiding groove 454 to thereby press the holder 442 against the bottle 9 and secure the bottle 9 between the holder 442 and the spin element 42. Meanwhile, the rotation motor assembly 46 may rotate the rotation platform 41, on which the bottle 9 is loaded, along with the spin element 42, the framework 43, and limiting component 44 to rotate about the main axis (X). The spin motor 473 drives the idle wheels 471 such that the band 472 may move at a high speed and stop instantaneously. This mechanism makes the bottle 9 along with the holder 442 spin at a high speed and stop instantaneously. As shown in FIG. 8, a whirlpool is formed by the liquid in the bottle 9, which makes an impurity (A) float around and then drop gradually. Referring to FIGS. 3 and 4, at this time, the bottle 9 loaded on the rotation platform 41 keeps rotating about the main axis (X), and then passes between and past the light emitting unit 5 and the light sensor 6.

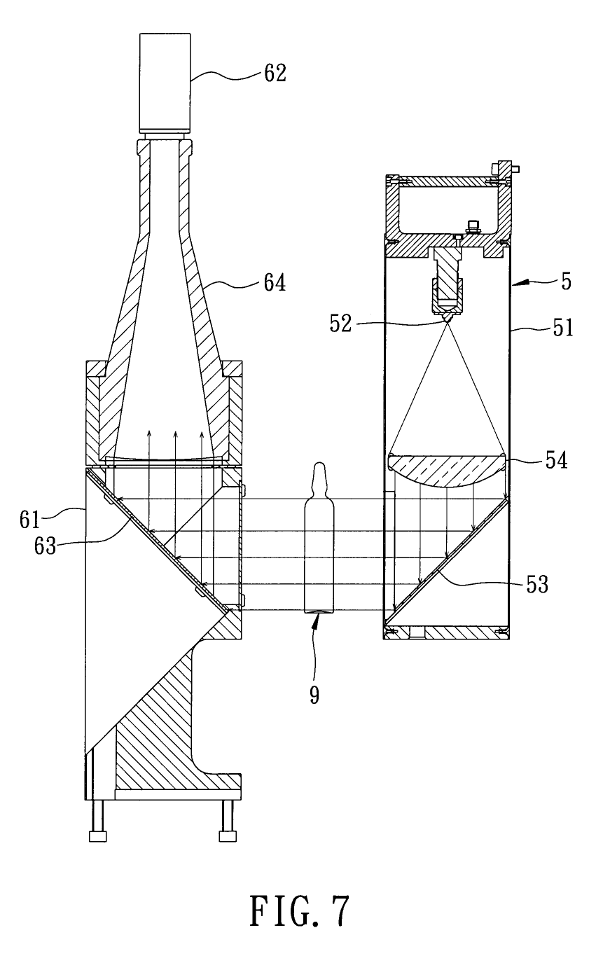

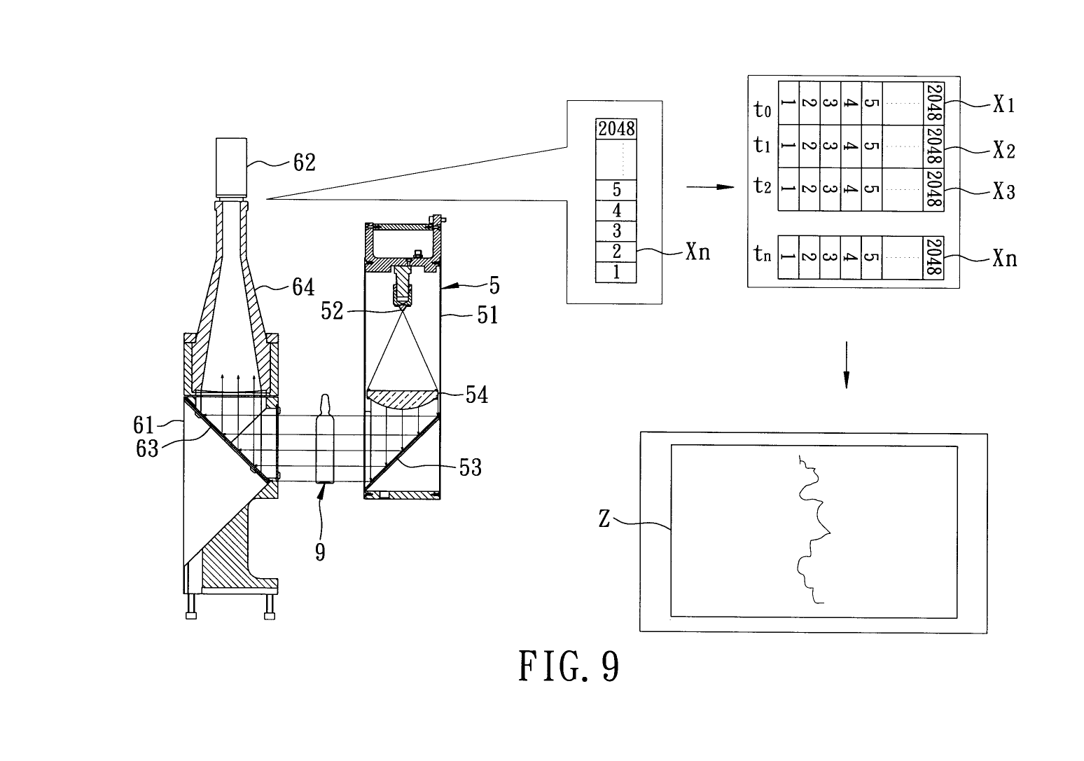

Referring to FIGS. 2, 7, and 9, after spinning of the bottle 9 has been terminated, the convex lens 54 collimates the light generated by the light emitting component 52 before projecting onto the first refractive lens 53. Next, the first refractive lens 53 guides the collimated light to pass through the bottle 9. Thereafter, the second refractive lens 63 of the light sensor unit 6 guides the light passing through the bottle 9 toward the image capturing device 62. The image capturing device 62 sequently captures several images (X1˜Xn) at time intervals (t₀˜tₙ) by means of linear scanning.

The following briefly describes the operation principle of the image capturing device 62. The image capturing device 62 may be considered a memory chip. When a photon collides with the memory chip, an electron will be ejected due to the photoelectric effect. Thus, the number of electrons is proportional to that of the photons, which is proportional to the light transmittance. These electrons are read out and processed by the image capturing device 62, producing a numerical pattern prior to generation of a converted video output. For example, when the image capturing device 62 has a resolution of 2048 pixels, a numerical value (X1˜Xn) of each pixel of the images varies, depending on the number of electrons (the number of photons).

The read module 71 of the analysis unit 7 sums up, the number of electrons (the number of photons) of all pixels of the images (X1˜Xn) and then calculate a mean value thereof. The comparison module 72 uses a subtraction method to perform comparison to generate the comparison result, in which a difference between each pixel of a first image and a corresponding pixel of an nth image is compared. In other words, a mean value of the first image would be compared to respective mean values of the second image, the third image, etc. up to the nth image. Assuming existence of an impurity, the impurity is present at different positions in the liquid over time and it passes through the incoming collimated light such that the image capturing device 62 captures non-uniform light intensities, which can be used to plot a track of the impurity moving over time. Thereafter, according to the numerical differences in the time interval, the comparison module 72 may determine whether a Z diagram of the impurity can be plotted. The Z diagram indicates spatial variations of the impurity over time.

Referring to FIG. 3, the bottle 9 loaded on the rotation platform 41 moves along with the rotation of the rotation platform 41. During this process, the bottle 9 sequently passes through the spin motor assembly 47, the light emitting unit 5, and the light sensor unit for the first detection. Thereafter, in some embodiments where a second light emitting unit 5 and a second light sensor 6 are included, the bottle 9 sequently passes through the other spin motor assembly 47, the other light emitting unit 5, and the other light sensor unit 6 for the second detection. Such a second detection of some embodiments can enhance the accuracy of detecting impurities.

Referring to FIGS. 3, 4, and 5, after the bottle 9 passes through the spin motor assembly 47, the light emitting unit 5, and the light sensor unit 6, the limiting component 44 uses the first slide element 441 that is displaced upwardly when the wheel 443 is positioned at the raised segment 454a of the guiding groove 454 to thereby release the bottle 9 from between the holder 442 and the spin element 42. The bottle 9 then moves from the rotation platform 41 to another one of the gear wheel 32, thereby finishing detection.

In addition, in the present invention, the control assembly 453 may be rotated clockwise or counterclockwise such that the guiding component 452 can follow the second slide elements 451 and move up or down along the main axis (X). This mechanism makes the limiting component 44 adjust a spacing between the spin element 42 and the limiting component 44 to correspond to different heights of the bottle 9.

In sum, the advantages of the present invention can be summarized as follows:

i) The present invention detects an impurity after a whirlpool is formed in liquid in the bottle 9, which makes the impurity float around and then drop gradually. Detection performed under such circumstances is such that detection errors are avoided and accuracy is enhanced.

ii) The light passing through the bottle 9 is collimated light such that the image capturing device 62 can receive the light effectively.

iii) The image capturing device 62 may include one of a CMOS image sensor and a CCD image sensor, which have advantages of low cost, low power loss, and high integration.

iv) Furthermore, the method of linear scanning and then calculating a mean value can avoid interference of noise, improving practicality.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An impurity detection device adapted for detecting impurities in liquid filled in a transparent bottle, said impurity detection device comprising:
a rotation unit on which the bottle is loaded, and that spins the bottle at a high speed and subsequently and instantaneously terminates spinning of the bottle;
a light emitting unit which generates light to pass through the bottle;
a light sensor unit for detecting the light passing through the bottle, and that captures a plurality of images of the light passed through the bottle after spinning of the bottle has been terminated and at different time intervals; and
an analysis unit that receives the captured images from the light sensor unit and compares the captured images to determine whether an impurity is present in the bottle.

2. The impurity detection device as claimed in claim 1, wherein said rotation unit includes a rotation platform, a spin element disposed on said rotation platform and on which the bottle is loaded, a rotation motor assembly that drives said rotation platform to rotate about a main axis of said rotation platform, and a spin motor assembly that drives said spin element to rotate about its own axis and thereafter instantaneously terminate rotation.

3. The impurity detection device as claimed in claim 2, wherein said spin motor assembly has a plurality of idle wheels, a band mounted on said idle wheels, and a spin motor for driving said band so that said idle wheels spin, said band being in frictional contact with said spin element to drive said spin element to rotate about its own axis.

4. The impurity detection device as claimed in claim 2, wherein said rotation unit includes a framework that is disposed on said rotation platform and that is located to one side of said spin element, and a limiting component that is slidably engaged with said framework, said limiting component having a holder that is rotatable freely about the main axis of said rotation platform and that has a spacing relative to said spin element so as to selectively secure and release the bottle between said limiting component and said spin element.

5. The impurity detection device as claimed in claim 4, wherein said framework has a guide pillar spaced apart from the main axis of said rotation platform and disposed on said rotation platform, said limiting component having a first slide element that is slidably engaged with said guide pillar and on which is mounted said holder.

6. The impurity detection device as claimed in claim 5, wherein said rotation unit further includes a linking assembly, and said limiting component has a wheel that is rotatably disposed on said sliding framework and that faces the main axis of said rotation platform, said linking assembly having a guiding component disposed to one side of said limiting component, said guiding component being formed with a guiding groove on an outer peripheral surface of said guiding component and that is slidably engaged with said wheel of said limiting component, said guiding groove having a raised segment and a lowered segment that are respectively raised and lowered in height along an axial direction of the main axis of said rotation platform, said first slide element of said limiting component being displaced downwardly when said wheel is positioned at said lowered segment of said guiding groove to thereby press said holder against the bottle and secure the bottle between said holder and said spin element, said first slide element of said limiting component being displaced upwardly when said wheel is position at said raised segment of said guiding groove to thereby release the bottle from between said holder and said spin element.

7. The impurity detection device as claimed in claim 1, wherein said rotation platform has a body portion that surrounds the main axis of said rotation platform and defines a hollow portion, said linking assembly having a plurality of second slide elements that are parallel to the main axis of said rotation platform and that extend through said hollow portion and said guiding component, and a control assembly that is disposed on said second slide elements and that extends through said guiding component along the main axis of said rotation platform, said control assembly allowing for manipulation so as to drive said guiding component and said limiting component to be displaced in the direction of the main axis of said rotation platform along said second slide elements and said guide pillar.

8. The impurity detection device as claimed in claim 1, wherein said light emitting unit includes a light transmission tube, a light emitting component disposed in said light transmission tube adjacent to an end thereof and which emits light, and a first refractive lens disposed in said light transmission tube adjacent to the other end thereof, said first refractive lens guiding the light generated by said light emitting component to pass through the bottle.

9. The impurity detection device as claimed in claim 8, wherein said light emitting unit further includes a convex lens that is disposed in said light transmission tube between said light emitting component and said first refractive lens, said convex lens reducing the scattering of the light generated by said light emitting component before projecting onto said first refractive lens.

10. The impurity detection device as claimed in claim 8, wherein said rotation platform has a body portion that surrounds the main axis of said rotation platform and defines a hollow portion, said light emitting unit being disposed on one side of said body portion at one of inside and outside said hollow portion, said light sensor unit being disposed on the other side of said body portion at the other one of inside and outside said hollow portion and opposing said light emitting unit.

11. The impurity detection device as claimed in claim 1, wherein said light sensor unit has a reception light tube, an image capturing device disposed on an end of said reception light tube, and a second refractive lens disposed in said reception light tube, said second refractive lens guiding the light passed through the bottle toward said image capturing device.

12. The impurity detection device as claimed in claim 11, wherein said image capturing device includes one of a charge coupled device image sensor and a complementary metal-oxide-semiconductor image sensor.

13. The impurity detection device as claimed in claim 11, wherein said light sensor unit further includes a telecentric lens disposed between and interconnecting said image capturing device and said reception light tube.

14. The impurity detection device as claimed in claim 1, wherein said analysis unit includes a read module coupled to said light sensor unit, a comparison module coupled to said read module, and a display module coupled to said comparison module, said read module reading the captured images captured by said light sensor unit, said comparison module comparing the captured images and generating a comparison result, said display module being adapted to perform control to display the comparison result on an output element.

15. The impurity detection device as claimed in claim 14, wherein said comparison module uses a subtraction method to perform comparison to generate the comparison result, in which a difference between each pixel of a first image and a corresponding pixel of an nth image is compared.

16. The impurity detection device as claimed in claim 14, wherein the output element is a display screen.
